(19) United States
(12) Patent Application Publication
(10) Pub. No.: US 2026/0166932 A1
(43) Pub. Date: Jun. 18, 2026

(54) SYSTEM FOR DETECTING A TOW BAR CONNECTED TO A VEHICLE

(71) Applicant: FCA US LLC, Auburn Hills, MI (US)

(72) Inventors: Jason L. Vincent, Auburn Hills, MI (US); Richard S. Silbert, Auburn Hills, MI (US); Patrick D. Reed, Auburn Hills, MI (US)

(21) Appl. No.: 18/978,537

(22) Filed: Dec. 12, 2024

(51) Int. Cl. B60D 1/14; B60R 1/00; B60R 1/26

(52) U.S. Cl. CPC B60D 1/143; B60R 1/003; B60R 1/26

(57) ABSTRACT

A method and system for detecting a tow bar on a vehicle may include determining that a tow bar is installed on the vehicle, determining that the tow bar is not connected to a towed apparatus, and sending a communication indicating that the tow bar is installed on the vehicle. The tow bar may be detected using an object sensor configured to sense objects near the vehicle. The object sensor may also detect when a towed apparatus is attached to the tow bar and when motion occurs near the tow bar of the vehicle.

### FIELD

The present disclosure relates to a system for detecting a tow bar connected to a vehicle.

### BACKGROUND

Tow bars, which may also be called draw bars, are commonly used for attaching trailers and other towed apparatuses to vehicles, and may be left installed in vehicles without a trailer or other towed apparatus attached. Because tow bars often extend beyond the vehicle at a low height from the ground, a pedestrian or other vehicle may accidentally collide with the tow bar without seeing the tow bar, and movement of the vehicle to which the tow bar is connected can cause the tow bar to impact other things because the tow bar extends outwardly beyond the vehicle.

### SUMMARY

In at least some implementations, a method for detecting a tow bar on a vehicle includes determining that a tow bar is installed on the vehicle, determining that the tow bar is not connected to a towed apparatus, and sending a communication indicating that the tow bar is installed on the vehicle.

In at least some implementations, the steps of determining that a tow bar is installed on the vehicle and determining that the tow bar is not connected includes using an object sensor to detect the tow bar.

In at least some implementations, the object sensor may be a camera having a field of view that includes an area of the vehicle to which the tow bar is connected, or the object sensor may be an ultrasonic sensor, an electromagnetic sensor, an infrared sensor, a lidar sensor or a radar sensor.

In at least some implementations, after the steps of detecting that the tow bar is installed on the vehicle and determining that the tow bar is not connected to a towed apparatus, the method further comprises determining a location of the vehicle and determining whether having the tow bar installed without a towed apparatus connected to the tow bar is permitted in the location.

In at least some implementations, when it is determined that the vehicle is located in an area where having the tow bar installed without a trailer connected is not permitted, the step of sending the communication includes communicating information indicative that having the tow bar installed is not permitted in the location.

In at least some implementations, communicating the information includes providing a communication to one or more of a user interface of the vehicle including a gauge cluster of the vehicle or an infotainment system, or an external device.

In at least some implementations, a step of detecting motion near the tow bar.

In at least some implementations, the step of detecting motion near the tow bar includes using an object sensor to detect that a pedestrian, moving object, or other vehicle is approaching the tow bar of the vehicle.

In at least some implementations, the object sensor may be a camera used in conjunction with image-recognition software configured to detect that a pedestrian, moving object, or other vehicle is approaching the tow bar of the vehicle or may be an ultrasonic sensor, an electromagnetic sensor, an infrared sensor, a lidar sensor, or a radar sensor configured to detect that a pedestrian, moving object, or other vehicle is approaching the tow bar of the vehicle.

In at least some implementations, the step of sending a communication that the tow bar is installed on the vehicle, includes communicating to a vehicle occupant through a user interface of the vehicle, including a gauge cluster of a vehicle or an infotainment system, or communicating through an external device, communicating to a pedestrian, moving object, or other vehicle through audible communication using a speaker, or visual communication using a vehicle light.

In at least some implementations, a vehicle includes a structure supporting the vehicle, a mount configured to receive a tow bar, an object sensor mounted to a rear portion of the vehicle and with a range including an area beyond the rear portion of the vehicle, a control system to receive communication from the object sensor, wherein the control system is configured to determine that the tow bar is installed on the vehicle based on information from the object sensor, determine that the tow bar is not connected to a towed apparatus, and to communicate that the tow bar is installed on the vehicle.

In at least some implementations, the object sensor may be a camera used in conjunction with image-recognition software configured to detect the tow bar or may be an ultrasonic sensor, an electromagnetic sensor, an infrared sensor, a lidar sensor or a radar sensor configured to detect the tow bar.

In at least some implementations, the control system is configured to, after the tow bar is determined to be installed on the vehicle and the tow bar is determined to not be connected to a towed apparatus, determine a location of the vehicle and whether having the tow bar installed without a trailer connected to the tow bar is permitted in the location.

In at least some implementations, when it is determined that the vehicle is located in an area where having the tow bar installed without a trailer connected is not permitted, the step of sending the communication includes communicating information indicative that having the tow bar installed is not permitted in the location.

In at least some implementations, communicating the information includes providing a communication to one or more of a user interface of the vehicle including a gauge cluster of the vehicle or an infotainment system, or an external device.

In at least some implementations, the control system is configured to determine when an object is moving near the tow bar.

In at least some implementations, to determine when an object is moving near the tow bar, the control system is configured to use information from the object sensor to detect that a pedestrian, moving object, or other vehicle is approaching the tow bar of the vehicle.

In at least some implementations, the object sensor may be a camera used in conjunction with image-recognition software, an ultrasonic sensor, an electromagnetic sensor, an infrared sensor, a lidar sensor or a radar sensor.

In at least some implementations, communicating that the tow bar is installed includes communication to a vehicle occupant through a user interface of the vehicle, including a gauge cluster of a vehicle or an infotainment system or through an external device, communication to a pedestrian, moving object, or other vehicle through audible communication using a speaker, or visual communication using a vehicle light.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a top view of a vehicle with a tow bar installed;

FIG. 2 is a side view of the vehicle with the tow bar installed; and

FIG. 3 is a flow chart of a method for detecting a tow bar.

### DETAILED DESCRIPTION

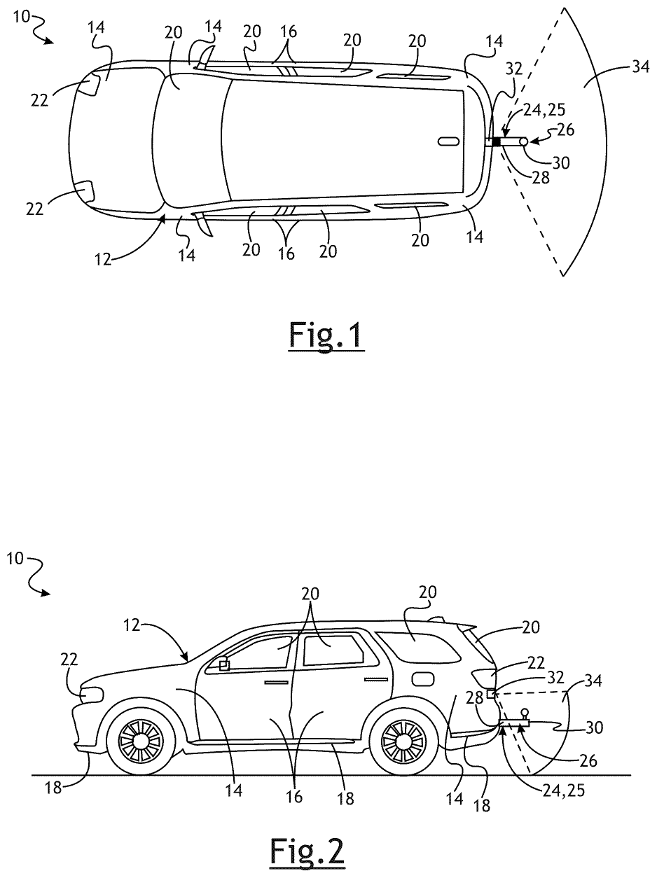

Referring in more detail to the drawings, FIGS. 1-2 show a vehicle 10 with a vehicle body 12, and in some implementations, a structure including a frame to support the vehicle body 12. The vehicle body 12 may include body panels 14, doors 16, trim components 18 (e.g. front and rear fascias or body assemblies) and windows 20 that define an interior and an exterior of the vehicle 10. A passenger compartment is within the interior of the vehicle 10 and may be configured to house one or more vehicle occupants.

Vehicle lights 22 may be mounted to or integrated with the body 12 and one or more lights 22 may be configured to illuminate a portion of an area beyond the exterior of the vehicle 10. Furthermore, the vehicle 10 may include one or more audio speakers arranged to provide sound that is audible beyond the exterior of the vehicle 10. To facilitate connecting a trailer or other towed apparatus to the vehicle 10, the vehicle 10 includes a mount 24 that is fixed to the vehicle structure (e.g. frame) and is configured to receive a tow bar 26 (the term tow bar is used to mean a tow bar or draw bar or similar component). In at least some implementations, such as is shown in FIGS. 1 and 2, the mount 24 may be positioned at the rear of the vehicle 10 and may include a receiver 25 configured to receive the tow bar 26. The receiver 25 may include a cavity that is complimentary in shape to the tow bar 26 to securely receive the tow bar 26 in the cavity.

The tow bar 26 is a structural component having a first end 28 and a second end 30. The first end 28 of the tow bar 26 may be removably received in the cavity of the receiver 25 and coupled to the mount 24. The second end 30 of the tow bar 26 may extend out of the receiver 25 and beyond the structure of the vehicle 10, that is, beyond the rear bumper, fascia or body assembly that defines part of the rear of the vehicle 10. The tow bar 26 is configured to connect with a trailer or other towed apparatus to couple that apparatus to the vehicle 10. Typically, the tow bar 26 is of steel or aluminum construction for strength and durability, although other materials, such as composites, may be used.

The vehicle 10 includes one or more object sensors 32 that may be positioned near the mount 24 and may be configured to detect the presence of one or more objects within a field of view 34 or range of the object sensor(s) 32. As shown in FIGS. 1-2, an object sensor 32 is positioned at the rear of the vehicle 10, near the mount 24 so that the field of view 34 or range of the object sensor 32 includes an area beyond the rear of the vehicle 10 and including at least part of the tow bar 26, or the area in which a tow bar 26 would be present if coupled to the vehicle 10.

The object sensor(s) 32 may be a camera or other type of sensor capable of detecting objects. For example, the camera may be a so-called back-up camera producing an image of an area behind the vehicle 10 that is shown on a display within the vehicle 10 when the vehicle 10 is put into a reverse drive mode. The camera may have a lens with a field of view 34 arranged to cover a desired area behind the vehicle 10. Other cameras and other types of sensors may be used to detect objects by emitting an output over a predetermined area and receiving reflections from the output portions of the emitted output reflect off objects within the predetermined area and are directed back to the object sensor. The object sensor(s) 32 may use outputs including light or sound, such as radio waves, ultrasonic sound waves, electromagnetic waves, different ranges or frequencies of light such as infrared or laser light, with non-limiting examples including radar and lidar sensors, among others.

The vehicle 10 may also include a location sensor, such as a global positioning system (GPS) that may be configured to determine the location of the vehicle. The location of the vehicle 10 may be communicated to other vehicle components to enable determination of the vehicle location for different purposes.

The vehicle 10 may also include a user interface capable of communicating information to an occupant of the vehicle 10 and for receiving inputs from an occupant. The user interface may be part of a vehicle infotainment system, and may include a display visible by one or more vehicle occupants within the interior of the vehicle 10, a tactile feedback system capable of tactilely communicating information to a user, or a speaker capable of audibly communicating information to the user. For example, the display may be part of a gauge cluster or center console and the infotainment system and user interface may be provided as desired within the vehicle 10. Via the user interface, various vehicle controls may be implemented or selected by a user, such as by a touch screen or other inputs like buttons or dials, and by which a remote device may be connected (e.g. a smart phone) and audio (e.g. radio/sound system) and other devices or systems may be accessed for user control. To manage operation of the user interface and related devices, components and systems, the user interface is part of or communicated with a vehicle control system.

The control system has one or more controllers or processors, memory and instructions or programs stored in the memory or otherwise accessible by the processor(s). In some implementations, the control system may have or be defined by a plurality of vehicle controllers independent or networked to each other. Each of the controllers may communicate with one or more vehicle components or system components. The control system may communicate with the object sensor(s) 32 to receive electrical signals when an object is detected near the vehicle 10, the vehicle lights 22, the speakers, the GPS, and the user interface. The control system may have or be communicated with a communications device of the vehicle 10 via which information may be received by the vehicle 10 and transmitted from the vehicle 10. The communications device may operate by one or more wireless protocols or systems, such as but not limited to, cellular, Wifi, Bluetooth or other wireless communication types.

An external device, such as a mobile phone, tablet or computer, may be separate from the vehicle 10 and selectively communicated with the vehicle to permit information and instructions to be conveyed between the external device and the vehicle 10. The external device may include a screen capable of displaying information to a user, a tactile feedback system capable of tactilely communicating information to a user, or a speaker capable of audibly communicating information to the user, as well as inputs by which a user may input information or commands/instructions into the external device. The external device may wirelessly communicate with the vehicle 10 or a server in communication with the vehicle 10.

With one or more object detection sensors 32, the presence of a tow bar 26 connected to the vehicle 10 can be detected. In at least some implementations, the tow bar 26 can be detected independently of a trailer or other towed apparatus. That is, the system described herein can detect the presence of a tow bar 26 at least when a trailer or other towed apparatus is not detected or determined to be connected to the vehicle 10. In this way, a user can be alerted to the fact that the tow bar 26 is connected to the vehicle 10 without a towed apparatus being connected to the vehicle 10, so that the user may remove the tow bar 26, if desired, or at least be aware of the presence of the tow bar 26. This may be desirable, in at least some implementations, because the tow bar 26 may extend beyond the rear of the vehicle 10 and pedestrians or objects may impact the tow bar 26 when moving near the vehicle 10, or may be impacted by the tow bar 26 when the vehicle 10 is moving.

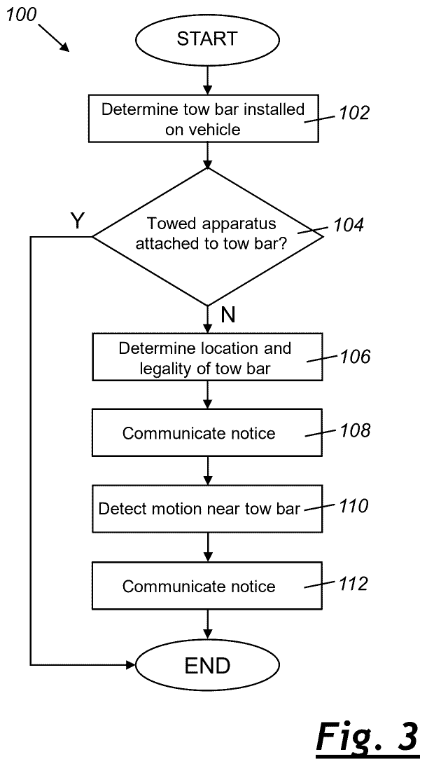

As shown in FIG. 3, a method 100 for detecting a tow bar 26 on a vehicle 10 may include a step 102 of determining that a tow bar 26 is installed on the vehicle 10. One or more of the object sensors 32 may be used to detect when the tow bar 26 is installed on the vehicle 10 at the receiver 25. For example, in embodiments where the object sensor 32 is a camera, the control system may have image recognition software that is able to interpret images from the image sensor to determine whether the tow bar 26 is present within the image or not. The image recognition software may include pre-stored images of the tow bar 26, and the control system may execute the image recognition software to compare the pre-stored images with the images from the image sensor. In embodiments using other sensors as previously disclosed herein, the tow bar 26 may be detected by reflected portions of the output from the object sensor(s) 32. An object detected by the object sensor 32 may be determined by the control system to be a tow bar 26 based on the location and size of the object detected being consistent with predetermined or known location (e.g. at the receiver) and size information relating to tow bars 26.

In step 104, it is determined if a towed apparatus, such as a trailer, vehicle rack, ladder, cargo carrier, snow plow, winch, tow hook, or other apparatus is connected to the vehicle 10 via the tow bar 26. The object sensor 32 may be used to determine whether the towed apparatus is attached to the tow bar 26, or otherwise determined to be in close proximity to the vehicle 10 indicating that the towed apparatus is connected to the vehicle 10. Like in step 102, if the object sensor 32 is a camera, image recognition software may be used to detect a towed apparatus. And if the object sensor 32 is a reflected output based sensor, then the received reflections can be reviewed to determine if a towed apparatus is present and attached to the tow bar 26 or otherwise located where expected for a towed apparatus. If a towed apparatus is detected in step 104, the method 100 may end. If a towed apparatus is note detected, then the method 100 proceeds to step 106, in at least some implementations.

In step 106, the location of the vehicle 10 is determined. This may be done using the location sensor (e.g. GPS). In some areas or jurisdictions, there are rules against leaving a tow bar 26 installed on a vehicle 10 when a towed apparatus is not coupled to the tow bar 26. Accordingly, once the vehicle location is determined, the method 100 continues to step 108 to determine if the vehicle 10 is in an area in which leaving a tow bar 26 installed on the vehicle 10 without a towed apparatus attached to the tow bar 26 is permitted. Information relating to areas or jurisdictions in which leaving a tow bar 26 installed on the vehicle 10 without being connected to a towed apparatus is not permitted may be stored in memory of the vehicle control system or on a remote device or remote server accessible to the vehicle control system (e.g. via the communications device). Based on the vehicle location from step 106 and the information regarding tow bar rules, it can be determined if the vehicle 10 is in an area in which the tow bar 26 should not be connected to the vehicle 10 without a towed apparatus being connected.

In step 108, when it is determined that the vehicle 10 is in an area in which the tow bar 26 should not be connected to the vehicle 10 without a towed apparatus being connected, a warning or notice is communicated from the control system to a vehicle occupant, owner of the vehicle 10, or user of the vehicle 10. The warning may indicate to the vehicle occupant, owner of the vehicle 10, or user of the vehicle 10 that the tow bar 26 is installed and should be removed. The warning may be communicated in any desired manner (e.g. visual, audible, tactile or some combination of these) and through any device or component accessible to the control system, such as the user interface, including the gauge cluster and/or the infotainment system or an external device. In at least some implementations, a notice is communicated that the tow bar 26 has been determined to be connected to the vehicle 10 without a towed apparatus being connected, and this is done even if step 106 is not performed. That is, one or more notices may be sent from the control system to alert a user that the tow bar 26 is connected even in areas in which that is not against a rule.

In step 110, motion from an object near the tow bar 26 is detected. Using the object sensor 32, an object moving in the area of and approaching the tow bar 26 may be detected. If the object sensor 32 is a camera, the control system may use image recognition software to compare consecutive images, where changes in the location of an object in the images may indicate motion and a direction of motion of an object near the tow bar 26 and toward the tow bar 26. Movement may be detected by other object sensors 32 by noting differences in object location over some period of time. The object in motion may be a pedestrian walking near the vehicle 10, a vehicle occupant after leaving the vehicle 10, another vehicle driving near the tow bar 26, or other moving objects. Upon detection of a moving object near the tow bar 26, the method 100 advances to step 112.

In step 112, a warning or notice is it is communicated to the moving object, possibly a vehicle occupant, pedestrian, or other vehicle, that the tow bar 26 is installed on the vehicle 10. Because the tow bar 26 may extend beyond the body 12 of the vehicle 10, it is possible for a vehicle occupant, pedestrian, or other vehicle to accidentally collide with the tow bar 26, or for the vehicle 10, when moving, to strike an object with the tow bar 26. To communicate that the tow bar 26 is installed on the vehicle 10, upon detecting motion near the vehicle 10, one or more vehicle lights 22 may be activated near the tow bar 26, an audible message or indication may be played through the speaker on the vehicle 10, or a message may be communicated to the user interface of the vehicle 10, including a gauge cluster of the vehicle 10 or an infotainment system. By alerting to the presence of the tow bar 26, a vehicle occupant, pedestrian, or other vehicle may avoid an accidental collision with the tow bar 26.

The method 100 described above is representative and is not intended to limit the scope of the innovations disclosed herein. In at least some implementations, the method 100 includes only steps 102, 104 and 108, and notice is provided to a user even when having a tow bar 26 connected to the vehicle 10 is not against a rule. Based on the notice, a user can decide if the tow bar 26 was left on by mistake and should be removed, or if the tow bar 26 will soon be used to connect a towed apparatus to the vehicle 10 and so the tow bar 26 should remain connected to the vehicle 10. Further, the additional notice from steps 110 and 112, of an object moving near and/or toward the tow bar 26, can also be provided without step 106, if desired. The method 100 may include other steps, and the steps may be performed in different orders, as desired for a given implementation.

What is claimed is:

1. A method for detecting a tow bar on a vehicle, comprising the steps of:
determining that a tow bar is installed on the vehicle;
determining that the tow bar is not connected to a towed apparatus; and
sending a communication indicating that the tow bar is installed on the vehicle.

2. The method of claim 1, wherein the steps of determining that a tow bar is installed on the vehicle and determining that the tow bar is not connected includes using an object sensor to detect the tow bar.

3. The method of claim 2, wherein the object sensor may be a camera having a field of view that includes an area of the vehicle to which the tow bar is connected, or the object sensor may be an ultrasonic sensor, an electromagnetic sensor, an infrared sensor, a lidar sensor or a radar sensor.

4. The method of claim 1, wherein after the steps of detecting that the tow bar is installed on the vehicle and determining that the tow bar is not connected to a towed apparatus, the method further comprises determining a location of the vehicle and determining whether having the tow bar installed without a towed apparatus connected to the tow bar is permitted in the location.

5. The method of claim 4, wherein, when it is determined that the vehicle is located in an area where having the tow bar installed without a towed apparatus connected is not permitted, the step of sending the communication includes communicating information indicative that having the tow bar installed is not permitted in the location.

6. The method of claim 5, wherein communicating the information includes providing a communication to one or more of a user interface of the vehicle including a gauge cluster of the vehicle or an infotainment system, or an external device.

7. The method of claim 1, further comprising a step of detecting motion near the tow bar.

8. The method of claim 7, wherein the step of detecting motion near the tow bar includes using an object sensor to detect that a pedestrian, moving object, or other vehicle is approaching the tow bar of the vehicle.

9. The method of claim 8, wherein the object sensor may be a camera used in conjunction with image-recognition software configured to detect that a pedestrian, moving object, or other vehicle is approaching the tow bar of the vehicle or may be an ultrasonic sensor, an electromagnetic sensor, an infrared sensor, a lidar sensor, or a radar sensor configured to detect that a pedestrian, moving object, or other vehicle is approaching the tow bar of the vehicle.

10. The method of claim 9, wherein the step of sending a communication that the tow bar is installed on the vehicle, includes communicating to a vehicle occupant through a user interface of the vehicle, including a gauge cluster of a vehicle or an infotainment system, or communicating through an external device, communicating to a pedestrian, moving object, or other vehicle through audible communication using a speaker, or visual communication using a vehicle light.

11. A vehicle comprising:
a structure supporting the vehicle;
a mount configured to receive a tow bar;
an object sensor mounted to a rear portion of the vehicle and with a range including an area beyond the rear portion of the vehicle;
a control system to receive communication from the object sensor, wherein the control system is configured to determine that the tow bar is installed on the vehicle based on information from the object sensor, determine that the tow bar is not connected to a towed apparatus, and to communicate that the tow bar is installed on the vehicle.

12. The vehicle of claim 11, wherein the object sensor may be a camera used in conjunction with image-recognition software configured to detect the tow bar or may be an ultrasonic sensor, an electromagnetic sensor, an infrared sensor, a lidar sensor or a radar sensor configured to detect the tow bar.

13. The vehicle of claim 11, wherein the control system is configured to, after the tow bar is determined to be installed on the vehicle and the tow bar is determined to not be connected to a towed apparatus, determine a location of the vehicle and whether having the tow bar installed without a towed apparatus connected to the tow bar is permitted in the location.

14. The vehicle of claim 13, wherein when it is determined that the vehicle is located in an area where having the tow bar installed without a towed apparatus connected is not permitted, the step of sending the communication includes communicating information indicative that having the tow bar installed is not permitted in the location.

15. The vehicle of claim 14, wherein communicating the information includes providing a communication to one or more of a user interface of the vehicle including a gauge cluster of the vehicle or an infotainment system, or an external device.

16. The vehicle of claim 15, wherein the control system is configured to determine when an object is moving near the tow bar.

17. The vehicle of claim 16, wherein, to determine when an object is moving near the tow bar, the control system is configured to use information from the object sensor to detect that a pedestrian, moving object, or other vehicle is approaching the tow bar of the vehicle.

18. The vehicle of claim 17, wherein the object sensor may be a camera used in conjunction with image-recognition software, an ultrasonic sensor, an electromagnetic sensor, an infrared sensor, a lidar sensor or a radar sensor.

19. The vehicle of claim 18, wherein communicating that the tow bar is installed includes communication to a vehicle occupant through a user interface of the vehicle, including a gauge cluster of a vehicle or an infotainment system or through an external device, communication to a pedestrian, moving object, or other vehicle through audible communication using a speaker, or visual communication using a vehicle light.
